(19) United States
(12) Patent Application Publication
(10) Pub. No.: US 2026/0349563 A1
(43) Pub. Date: Nov. 5, 2026

(54) TOUCH SENSOR PANEL INCLUDING A DRIFT SENSOR

(71) Applicant: Apple Inc., Cupertino, CA (US)

(72) Inventors: Dirk DE BRUYKER, San Jose, CA (US); Benedict DREVNIOK, San Francisco, CA (US); Eric S. WINOKUR, Redwood City, CA (US); Andy J. ZHOU, San Jose, CA (US); John B. LAFLEN, Elk Grove, CA (US); Meera PUNJIYA, South San Francisco, CA (US)

(21) Appl. No.: 19/657,848

(22) Filed: Apr. 24, 2026

Related U.S. Application Data
(60) Provisional application No. 63/972,505, filed on Jan. 30, 2026.
(60) Provisional application No. 63/797,888, filed on Apr. 30, 2025.

(51) Int. Cl. G06F 3/041; G06F 3/044

(52) U.S. Cl. CPC G06F 3/041662; G06F 3/04164; G06F 3/0445; G06F 3/0446

(57) ABSTRACT

A touch sensor panel or touch screen can include one or more drift sensors. For example, a touch sensor panel can include a plurality of touch electrodes in a pixelated configuration. The self-capacitance (or mutual capacitance) of the plurality of touch electrodes can be sensed. The touch sensor panel can also include one or more drift traces in a layer between the plurality of touch electrodes and a display. The one or more drift traces can be driven and corresponding touch electrodes of the plurality of touch electrodes can be sense a mutual capacitance therebetween as a drift sensor. The touch sensor panel or touch screen including the one or more drift sensors can mitigate the effects of thermal drift on the self-capacitance (or mutual capacitance) measurements of the touch sensor panel or screen.

### CROSS-REFERENCE TO RELATED APPLICATIONS

This application claims the benefit of U.S. Provisional Application No. 63/972,505, filed January 30, 2026, and U.S. Provisional Application No. 63/797,888, filed April 30, 2025, the contents of which are incorporated herein by reference in their entireties for all purposes.

### Field of the Disclosure

This relates generally to touch sensor panels/screens, and more particularly to touch sensor panels/screens including one or more drift sensors.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular, are popular because of their ease and versatility of operation as well as their declining price. Touch screens can include a touch sensor panel, which can be a clear panel with a touch-sensitive surface, and a display device such as a liquid crystal display (LCD), light emitting diode (LED) display or organic light emitting diode (OLED) display that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electrical fields used to detect touch can extend beyond the surface of the display, and objects approaching near the surface may be detected near the surface without actually touching the surface.

Capacitive touch sensor panels can be formed by a matrix of partially or fully transparent or non-transparent conductive plates (e.g., touch electrodes) made of materials such as Indium Tin Oxide (ITO). In some examples, the conductive plates can be formed from other materials including conductive polymers, metal mesh, graphene, nanowires (e.g., silver nanowires) or nanotubes (e.g., carbon nanotubes). It is due in part to their substantial transparency that some capacitive touch sensor panels can be overlaid on a display to form a touch screen, as described above. Some touch screens can be formed by at least partially integrating touch sensing circuitry into a display pixel stack-up (i.e., the stacked material layers forming the display pixels).

### Summary of the Disclosure

This relates to touch sensor panels (or touch screens or touch-sensitive surfaces) with a drift sensor. A touch sensor panel or touch screen can include one or more drift sensors. For example, a touch sensor panel can include a plurality of touch electrodes in a pixelated configuration. The self-capacitance of the plurality of touch electrodes can be sensed. The touch sensor panel can also include one or more drift traces in a layer between the plurality of touch electrodes and a display. The one or more drift traces can be driven and corresponding touch electrodes of the plurality of touch electrodes can sense a mutual capacitance therebetween as a drift sensor. The touch sensor panel or touch screen including the one or more drift sensors can mitigate the effects of thermal drift on the self-capacitance measurements of the touch sensor panel or screen.

### BRIEF DESCRIPTION OF THE DRAWINGS

FIGS. 1A-1E illustrate example systems that can include a touch screen according to examples of the disclosure.

FIG. 2 illustrates an example computing system including a touch screen according to examples of the disclosure.

FIG. 3A illustrates an example touch sensor circuit corresponding to a self-capacitance measurement of a touch node electrode and sensing circuit according to examples of the disclosure.

FIG. 3B illustrates an example touch sensor circuit corresponding to a mutual-capacitance drive line and sense line and sensing circuit according to examples of the disclosure.

FIG. 4A illustrates touch screen with touch electrodes arranged in rows and columns according to examples of the disclosure.

FIG. 4B illustrates touch screen with touch node electrodes arranged in a pixelated touch node electrode configuration according to examples of the disclosure.

FIG. 5 illustrates an example touch screen stack-up including a metal mesh layer according to examples of the disclosure.

FIGS. 6A-6B illustrate views of a portion of an example touch sensor panel including a drift sensor according to examples of the disclosure.

FIGS. 7A-7B illustrate views of a portion of an example touch sensor panel including a drift sensor and additional electrodes according to examples of the disclosure.

FIG. 8 illustrates a top-down view of a portion of an example touch sensor panel according to examples of the disclosure.

FIG. 9 is a flow diagram illustrating a method of measuring a self-capacitance of touch electrodes of an example touch sensor panel that incorporates drift compensation according to some examples of the disclosure.

FIG. 10 illustrates a view of a portion of an example touch sensor panel including a drift sensor implemented in a mutual capacitance sensing architecture according to examples of the disclosure.

FIG. 11 is a flow diagram illustrating a method of measuring a mutual-capacitance of touch electrodes of an example touch sensor panel that incorporates drift compensation according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to touch sensor panels (or touch screens or touch-sensitive surfaces) with a drift sensor. A touch sensor panel or touch screen can include one or more drift sensors. For example, a touch sensor panel can include a plurality of touch electrodes in a pixelated configuration. The self-capacitance of the plurality of touch electrodes can be sensed. The touch sensor panel can also include one or more drift traces in a layer between the plurality of touch electrodes and a display. The one or more drift traces can be driven and corresponding touch electrodes of the plurality of touch electrodes can sense a mutual capacitance therebetween as a drift sensor. The touch sensor panel or touch screen including the one or more drift sensors can mitigate the effects of thermal drift on the self-capacitance measurements of the touch sensor panel or screen.

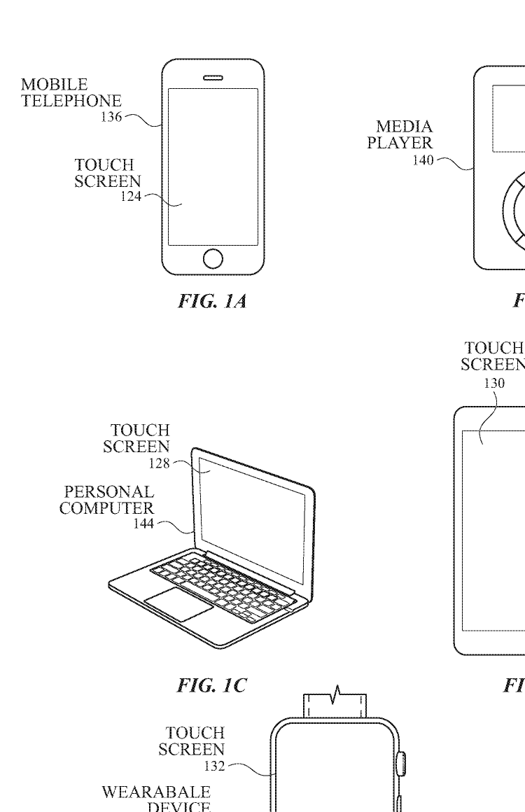

FIGS. 1A-1E illustrate example systems that can include a touch screen according to examples of the disclosure. FIG. 1A illustrates an example mobile telephone 136 that includes a touch screen 124 according to examples of the disclosure. FIG. 1B illustrates an example digital media player 140 that includes a touch screen 126 according to examples of the disclosure. FIG. 1C illustrates an example personal computer 144 that includes a touch screen 128 according to examples of the disclosure. FIG. 1D illustrates an example tablet computing device 148 that includes a touch screen 130 according to examples of the disclosure. FIG. 1E illustrates an example wearable device 150 that includes a touch screen 132 and can be attached to a user using a strap 152 according to examples of the disclosure. It is understood that a touch screen can be implemented in other devices as well.

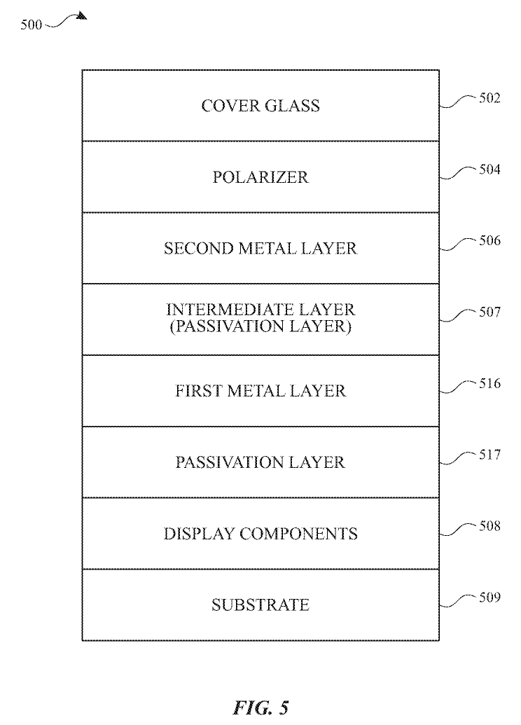

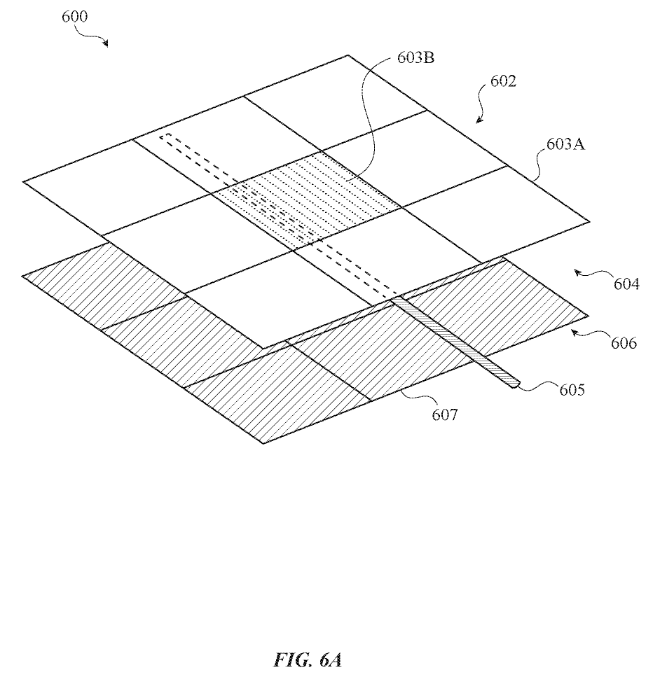

In some examples, touch screens 124, 126, 128, 130 and 132 can be based on self-capacitance. A self-capacitance based touch system can include a matrix of small, individual plates of conductive material or groups of individual plates of conductive material forming larger conductive regions that can be referred to as touch electrodes or as touch node electrodes (as described below with reference to FIG. 4B). For example, a touch screen can include a plurality of individual touch electrodes, each touch electrode identifying or representing a unique location (e.g., a touch node) on the touch screen at which touch or proximity is to be sensed, and each touch node electrode being electrically isolated from the other touch node electrodes in the touch screen/panel. Such a touch screen can be referred to as a pixelated self-capacitance touch screen, though it is understood that in some examples, the touch node electrodes on the touch screen can be used to perform scans other than self-capacitance scans on the touch screen (e.g., mutual capacitance scans). During operation, a touch node electrode can be stimulated with an alternating current (AC) waveform, and the self-capacitance to ground of the touch node electrode can be measured. As an object approaches the touch node electrode, the self-capacitance to ground of the touch node electrode can change (e.g., increase). This change in the self-capacitance of the touch node electrode can be detected and measured by the touch sensing system to determine the positions of multiple objects when they touch, or come in proximity to, the touch screen. In some examples, the touch node electrodes of a self-capacitance based touch system can be formed from rows and columns of conductive material, and changes in the self-capacitance to ground of the rows and columns can be detected, similar to above. In some examples, a touch screen can be multi-touch, single touch, projection scan, full-imaging multi-touch, capacitive touch, etc.

In some examples, touch screens 124, 126, 128, 130 and 132 can be based on mutual capacitance. A mutual capacitance based touch system can include electrodes arranged as drive and sense lines that may cross over each other on different layers (in a double-sided configuration), or may be adjacent to each other on the same layer (e.g., as described below with reference to FIG. 4A). The crossing or adjacent locations can form touch nodes. During operation, the drive line can be stimulated with an AC waveform and the mutual capacitance of the touch node can be measured. As an object approaches the touch node, the mutual capacitance of the touch node can change (e.g., decrease). This change in the mutual capacitance of the touch node can be detected and measured by the touch sensing system to determine the positions of multiple objects when they touch, or come in proximity to, the touch screen. As described herein, in some examples, a mutual capacitance based touch system can form touch nodes from a matrix of small, individual plates of conductive material.

In some examples, touch screens 124, 126, 128, 130 and 132 can be based on mutual capacitance and/or self-capacitance. The electrodes can be arranged as a matrix of small, individual plates of conductive material (e.g., as in touch node electrodes 408 in touch screen 402 in FIG. 4B) or as drive lines and sense lines (e.g., as in touch electrodes 404 and touch electrodes 406 in touch screen 400 in FIG. 4A), or in another pattern. The electrodes can be configurable for mutual capacitance or self-capacitance sensing or a combination of mutual and self-capacitance sensing. For example, in one mode of operation electrodes can be configured to sense mutual capacitance between electrodes and in a different mode of operation electrodes can be configured to sense self-capacitance of electrodes. In some examples, some of the electrodes can be configured to sense mutual capacitance therebetween and some of the electrodes can be configured to sense self-capacitance thereof.

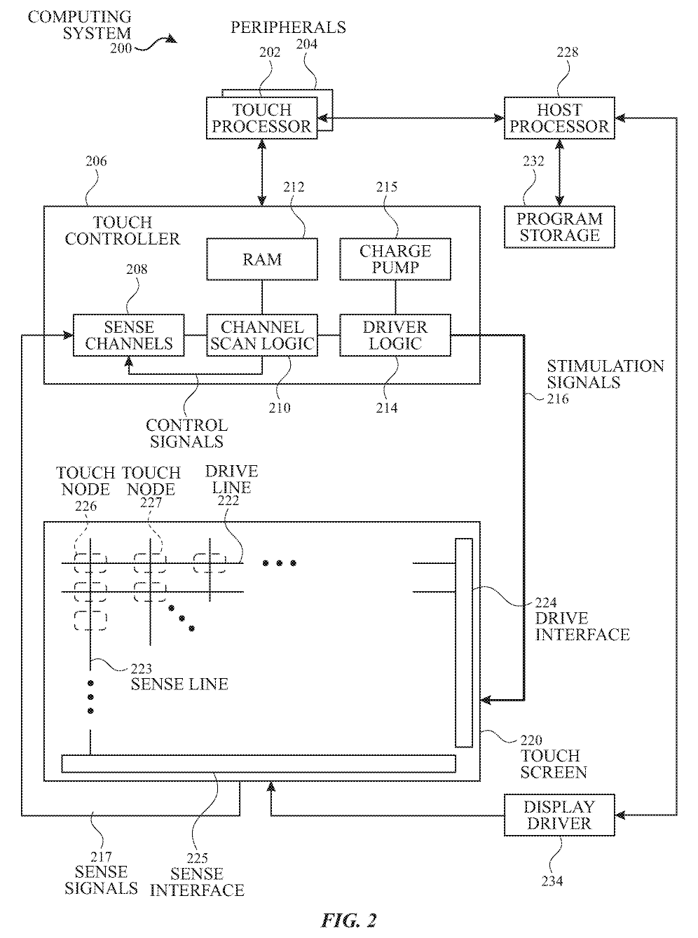

FIG. 2 illustrates an example computing system 200 including a touch screen according to examples of the disclosure. Computing system 200 can be included in, for example, a mobile phone, tablet, touchpad, portable or desktop computer, portable media player, wearable device or any mobile or non-mobile computing device that includes a touch screen or touch sensor panel. Computing system 200 can include a touch sensing system including one or more touch processors 202, peripherals 204, a touch controller 206, and touch sensing circuitry (described in more detail below). Peripherals 204 can include, but are not limited to, random access memory (RAM) or other types of memory or storage, watchdog timers and the like. Touch controller 206 can include, but is not limited to, one or more sense channels 208, channel scan logic 210, driver logic 214, and charge pump 215. Channel scan logic 210 can access RAM 212, autonomously read data from the sense channels and provide control for the sense channels. In addition, channel scan logic 210 can control driver logic 214 to generate stimulation signals 216 at various frequencies and/or phases that can be selectively applied to drive regions of the touch sensing circuitry of touch screen 220, as described in more detail below. The charge pump 215 may be configured to generate one or more voltages higher than the supply voltage, the boosted voltages being used to drive the touch electrodes. By providing a higher drive voltage, the charge pump improves the sensitivity and signal-to-noise ratio of capacitive touch detection. In some examples, touch controller 206, touch processor 202 and peripherals 204 can be integrated into a single application specific integrated circuit (ASIC), and in some examples can be integrated with touch screen 220 itself.

It should be apparent that the architecture shown in FIG. 2 is only one example architecture of computing system 200, and that the system could have more or fewer components than shown, or a different configuration of components. In some examples, computing system 200 can include an energy storage device (e.g., a battery) to provide a power supply and/or communication circuitry to provide for wired or wireless communication (e.g., cellular, Bluetooth, Wi-Fi, etc.). The various components shown in FIG. 2 can be implemented in hardware, software, firmware or any combination thereof, including one or more signal processing and/or application specific integrated circuits.

Computing system 200 can include a host processor 228 for receiving outputs from touch processor 202 and performing actions based on the outputs. For example, host processor 228 can be connected to program storage 232 and a display driver 234 (e.g., a Liquid-Crystal Display (LCD) driver), which is sometimes referred to as a display controller. It is understood that although some examples of the disclosure may be described with reference to LCD displays, the scope of the disclosure is not so limited and can extend to other types of displays, such as Light-Emitting Diode (LED) displays, including Organic LED (OLED), Active-Matrix Organic LED (AMOLED) and Passive-Matrix Organic LED (PMOLED) displays. Display driver 234 can provide voltages on select (e.g., gate) lines to each pixel transistor and can provide data signals along data lines to these same transistors to control the pixel display image.

Host processor 228 can use display driver 234 to generate a display image on touch screen 220, such as a display image of a user interface (UI), and can use touch processor 202 and touch controller 206 to detect a touch on or near touch screen 220, such as a touch input to the displayed UI. The touch input can be used by computer programs stored in program storage 232 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 228 can also perform additional functions that may not be related to touch processing.

Note that one or more of the functions described herein, can be performed by firmware stored in memory (e.g., one of the peripherals 204 in FIG. 2) and executed by touch processor 202, or stored in program storage 232 and executed by host processor 228. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. In some examples, RAM 212 or program storage 232 (or both) can be a non-transitory computer readable storage medium. One or both of RAM 212 and program storage 232 can have stored therein instructions, which when executed by touch processor 202 or host processor 228 or both, can cause the device including computing system 200 to perform one or more functions and methods of one or more examples of this disclosure. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a compact disc (CD), CD-R, CD-RW, digital versatile disc (DVD), DVD-R, or DVD-RW, or flash memory such as compact flash cards, secured digital cards, universal serial bus (USB) memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

Touch screen 220 can be used to derive touch information at multiple discrete locations of the touch screen, referred to herein as touch nodes. Touch screen 220 can include touch sensing circuitry that can include a capacitive sensing medium having a plurality of drive lines 222 and a plurality of sense lines 223. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 222 can be driven by stimulation signals 216 from driver logic 214 through a drive interface 224, and resulting sense signals 217 generated in sense lines 223 can be transmitted through a sense interface 225 to sense channels 208 in touch controller 206. In this way, drive lines and sense lines can be part of the touch sensing circuitry that can interact to form capacitive sensing nodes, which can be thought of as touch picture elements (touch pixels) and referred to herein as touch nodes, such as touch nodes 226 and 227. This way of understanding can be particularly useful when touch screen 220 is viewed as capturing an “image” of touch (“touch image”). In other words, after touch controller 206 has determined whether a touch has been detected at each touch nodes in the touch screen, the pattern of touch nodes in the touch screen at which a touch occurred can be thought of as an “image” of touch (e.g., a pattern of fingers touching the touch screen). As used herein, an electrical component “coupled to” or “connected to” another electrical component encompasses a direct or indirect connection providing electrical path for communication or operation between the coupled components. Thus, for example, drive lines 222 may be directly connected to driver logic 214 or indirectly connected to driver logic 214 via drive interface 224 and sense lines 223 may be directly connected to sense channels 208 or indirectly connected to sense channels 208 via sense interface 225. In either case an electrical path for driving and/or sensing the touch nodes can be provided.

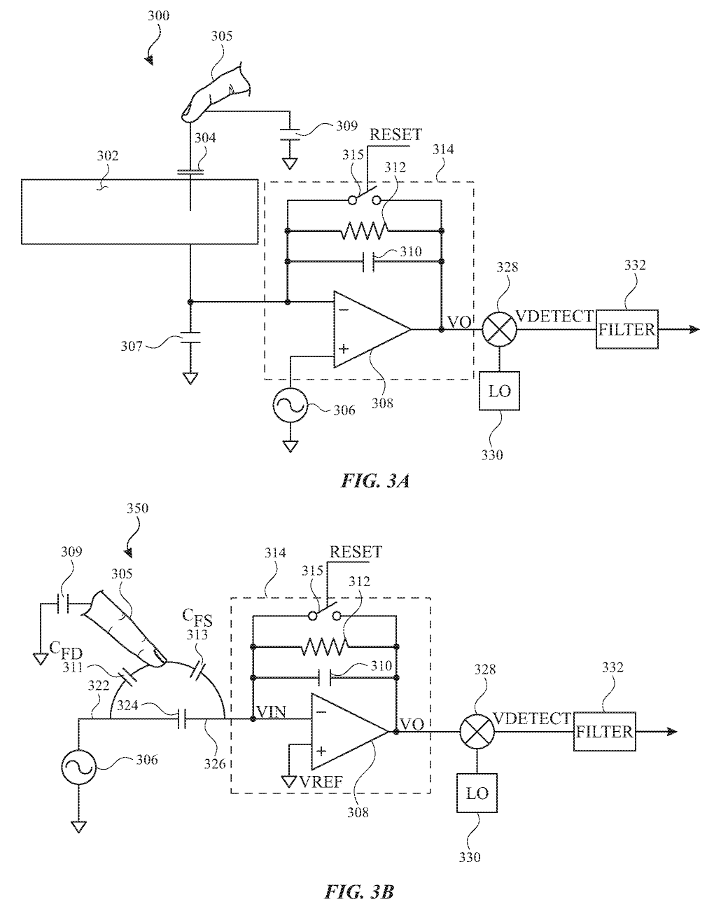

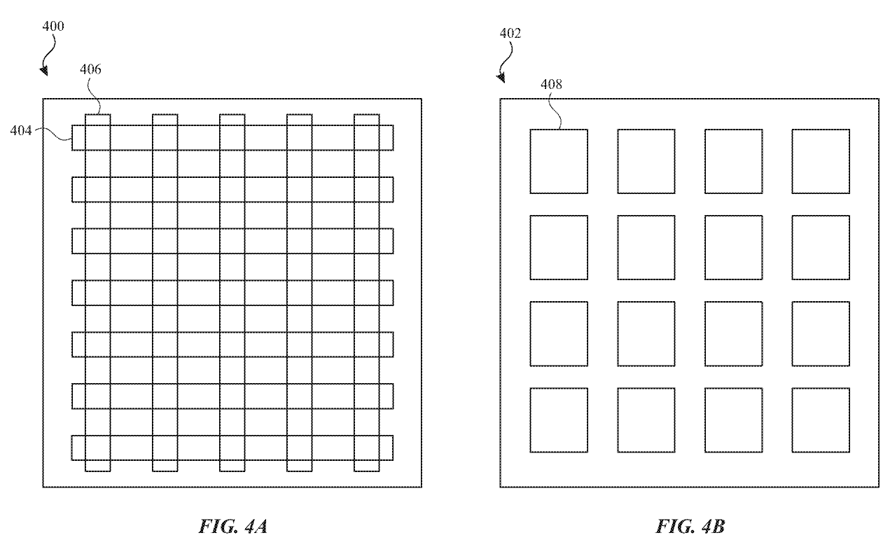

FIG. 3A illustrates an example touch sensor circuit 300 corresponding to a self-capacitance measurement of a touch node electrode 302 and sensing circuit 314 according to examples of the disclosure. Touch node electrode 302 can correspond to a touch electrode 404 or 406 of touch screen 400 or a touch node electrode 408 of touch screen 402. Touch node electrode 302 can have an inherent self-capacitance to ground associated with it, and also an additional self-capacitance to ground that is formed when an object, such as finger 305, is in proximity to or touching the electrode. The total self-capacitance to ground of touch node electrode 302 can be illustrated as capacitance 304. Touch node electrode 302 can be coupled to sensing circuit 314. Sensing circuit 314 can include an operational amplifier 308, feedback resistor 312 and feedback capacitor 310, although other configurations can be employed. For example, feedback resistor 312 can be replaced by a switched capacitor resistor in order to minimize a parasitic capacitance effect that can be caused by a variable feedback resistor. Touch node electrode 302 can be coupled to the inverting input (-) of operational amplifier 308. An AC voltage source 306 (V_{ac}) can be coupled to the non-inverting input (+) of operational amplifier 308. Touch sensor circuit 300 can be configured to sense changes (e.g., increases) in the total self-capacitance 304 of the touch node electrode 302 induced by a finger or object either touching or in proximity to the touch sensor panel. Output 320 can be used by a processor to determine the presence of a proximity or touch event, or the output can be inputted into a discrete logic network to determine the presence of a proximity or touch event.

FIG. 3B illustrates and example touch sensor circuit 350 corresponding to a mutual-capacitance drive line 322 and sense line 326 and sensing circuit 314 according to examples of the disclosure. Drive line 322 can be stimulated by stimulation signal 306 (e.g., an AC voltage signal). Stimulation signal 306 can be capacitively coupled to sense line 326 through mutual capacitance 324 between drive line 322 and the sense line. When a finger 305 or object approaches the touch node created by the intersection of drive line 322 and sense line 326, mutual capacitance 324 can change (e.g., decrease) (e.g., due to capacitive coupling indicated by capacitances C_{FD} 311 and C_{FS} 313, which can be formed between drive line 322, finger 305 and sense line 326). This change in mutual capacitance 324 can be detected to indicate a touch or proximity event at the touch node, as described herein. The sense signal coupled onto sense line 326 can be received by sensing circuit 314. Sensing circuit 314 can include operational amplifier 308 and at least one of a feedback resistor 312 and a feedback capacitor 310. FIG. 3B illustrates a general case in which both resistive and capacitive feedback elements are utilized. The sense signal (referred to as Vin) can be inputted into the inverting input of operational amplifier 308, and the non-inverting input of the operational amplifier can be coupled to a reference voltage V_{ref}. Operational amplifier 308 can drive its output to voltage Vₒ to keep Vᵢₙ substantially equal to V_{ref}, and can therefore maintain Vᵢₙ constant or virtually grounded. A person of skill in the art would understand that in this context, equal can include deviations of up to 15%. Therefore, the gain of sensing circuit 314 can be mostly a function of the ratio of mutual capacitance 324 and the feedback impedance, comprised of feedback resistor 312 and/or feedback capacitor 310. The output of sensing circuit 314 Vo can be filtered and heterodyned or homodyned by being fed into multiplier 328, where Vo can be multiplied with local oscillator 330 to produce V_{detect}. V_{detect} can be inputted into filter 332. One skilled in the art will recognize that the placement of filter 332 can be varied; thus, the filter can be placed after multiplier 328, as illustrated, or two filters can be employed: one before the multiplier and one after the multiplier. In some examples, there can be no filter at all. The direct current (DC) portion of V_{detect} can be used to determine if a touch or proximity event has occurred. Note that while FIGS. 3A-3B indicate the demodulation at multiplier 328 occurs in the analog domain, output Vo may be digitized by an analog-to-digital converter (ADC), and blocks 328, 332 and 330 may be implemented in a digital fashion (e.g., 328 can be a digital demodulator, 332 can be a digital filter, and 330 can be a digital NCO (Numerical Controlled Oscillator).

Referring back to FIG. 2, in some examples, touch screen 220 can be an integrated touch screen in which touch sensing circuit elements of the touch sensing system can be integrated into the display pixel stack-ups of a display. The circuit elements in touch screen 220 can include, for example, elements that can exist in LCD or other displays (LED display, OLED display, etc.), such as one or more pixel transistors (e.g., thin film transistors (TFTs)), gate lines, data lines, pixel electrodes and common electrodes. In a given display pixel, a voltage between a pixel electrode and a common electrode can control a luminance of the display pixel. The voltage on the pixel electrode can be supplied by a data line through a pixel transistor, which can be controlled by a gate line. It is noted that circuit elements are not limited to whole circuit components, such as a whole capacitor, a whole transistor, etc., but can include portions of circuitry, such as only one of the two plates of a parallel plate capacitor.

FIG. 4A illustrates touch screen 400 with touch electrodes 404 and 406 arranged in rows and columns according to examples of the disclosure. Specifically, touch screen 400 can include a plurality of touch electrodes 404 disposed as rows, and a plurality of touch electrodes 406 disposed as columns. Touch electrodes 404 and touch electrodes 406 can be on the same or different material layers on touch screen 400, and can intersect with each other, as illustrated in FIG. 4A. In some examples, the electrodes can be formed on opposite sides of a transparent (partially or fully) substrate and from a transparent (partially or fully) semiconductor material, such as ITO, though other materials are possible. Electrodes displayed on layers on different sides of the substrate can be referred to herein as a double-sided sensor. In some examples, touch screen 400 can sense the self-capacitance of touch electrodes 404 and 406 to detect touch and/or proximity activity on touch screen 400, and in some examples, touch screen 400 can sense the mutual capacitance between touch electrodes 404 and 406 to detect touch and/or proximity activity on touch screen 400.

Although FIG. 4A illustrates touch electrodes 404 and touch electrodes 406 as rectangular electrodes, in some examples, other shapes and configurations are possible for row and column electrodes. For example, in some examples, some or all row and column electrodes can be formed from multiple touch electrodes formed on one side of substrate from a transparent (partially or fully) semiconductor material. The touch electrodes of a particular row or column can be interconnected by coupling segments and/or bridges. Row and column electrodes formed in a layer on the same side of a substrate can be referred to herein as a single-sided sensor. As described in more detail below, row and column electrodes can have other shapes. Additionally, although primarily described in terms of a row-column configuration, it is understood that in some examples, the same principles can be applied to two-axis array of touch nodes in a non-rectilinear arrangement.

FIG. 4B illustrates touch screen 402 with touch node electrodes 408 arranged in a pixelated touch node electrode configuration according to examples of the disclosure. Specifically, touch screen 402 can include a plurality of individual touch node electrodes 408, each touch node electrode identifying or representing a unique location on the touch screen at which touch or proximity (i.e., a touch or proximity event) is to be sensed, and each touch node electrode being electrically isolated from the other touch node electrodes in the touch screen/panel, as previously described. Touch node electrodes 408 can be on the same or different material layers on touch screen 402. In some examples, touch screen 402 can sense the self-capacitance of touch node electrodes 408 to detect touch and/or proximity activity on touch screen 402, and in some examples, touch screen 402 can sense the mutual capacitance between touch node electrodes 408 to detect touch and/or proximity activity on touch screen 402.

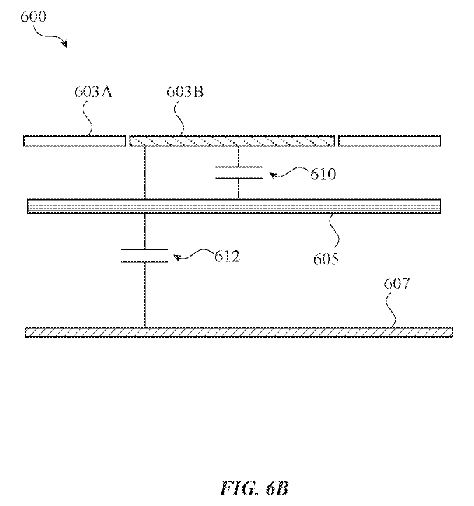

In some examples, some or all of the touch electrodes of a touch screen can be formed from a metal mesh in one or more layers (or from other conductive materials including transparent or non-transparent conductors). FIG. 5 illustrates an example touch screen stack-up including a metal mesh layer according to examples of the disclosure. Touch screen 500 can include a substrate 509 (e.g., a printed circuit board) upon which display components 508 (e.g., LEDs or other light emitting components and circuitry) can be mounted. In some examples, the display components 508 can be partially or fully embedded in substrate 509 (e.g., the components can be placed in depressions in the substrate). Substrate 509 can include routing traces in one or more layers to route the display components (e.g., LEDs) to display driving

circuitry (e.g., display driver 234). The stack-up of touch screen 500 can also include one or more passivation layers deposited over the display components 508. For example, the stack-up of touch screen 500 illustrated in FIG. 5 can include an intermediate layer / passivation layer 507 (e.g., transparent epoxy), between first metal layer 516 and second metal layer 506, and passivation layer 517. Passivation layers 507 and 517 can planarize the surface for respective metal mesh layers. Additionally, the passivation layers can provide electrical isolation (e.g., between metal mesh layers and between the LEDs and a metal mesh layer). First metal layer 516 (e.g., copper, silver, etc.) can be deposited on the planarized surface of the passivation layer 517 over the display components 508, and second metal layer 506 (e.g., copper, silver, etc.) can be deposited on the planarized surface of passivation layer 507. In some examples, the passivation layer 517 can include material to encapsulate the display components to protect them from corrosion or other environmental exposure. Second metal layer 506 and/or first metal layer 516 can include a pattern of conductor material in a mesh pattern. In some examples, second metal layer 506 and first metal layer 516 can be coupled by one or more vias (e.g., through intermediate layer / passivation layer 507. Additionally, although not shown in FIG. 5, a border region around the display active area can include metallization (or other conductive material) that may or may not be a metal mesh pattern. In some examples, metal mesh is formed of a non-transparent material, but the metal mesh wires are sufficiently thin and sparse to appear transparent to the human eye. The touch electrodes (and some routing) as described herein can be formed in the metal mesh layer(s) from portions of the metal mesh. In some examples, polarizer 504 can be disposed above the second metal layer 506 (optionally with another planarization layer disposed over the second metal layer 506). Cover glass (or front crystal) 502 can be disposed over polarizer 504 and form the outer surface of touch screen 500. It is understood that although two metal mesh layers (and two corresponding planarization layers) are illustrated and described, in some examples more or fewer metal mesh layers (and corresponding planarization layers) can be implemented. Additionally, it is understood that in some examples, display components 508, substrate 509 and/or passivation layer 517 can be replaced by a thin-film transistor (TFT) LCD display (or other types of displays), in some examples. Additionally, it is understood that polarizer 504 can include one or more transparent layers including a polarizer, adhesive layers (e.g., optically clear adhesive) and protective layers.

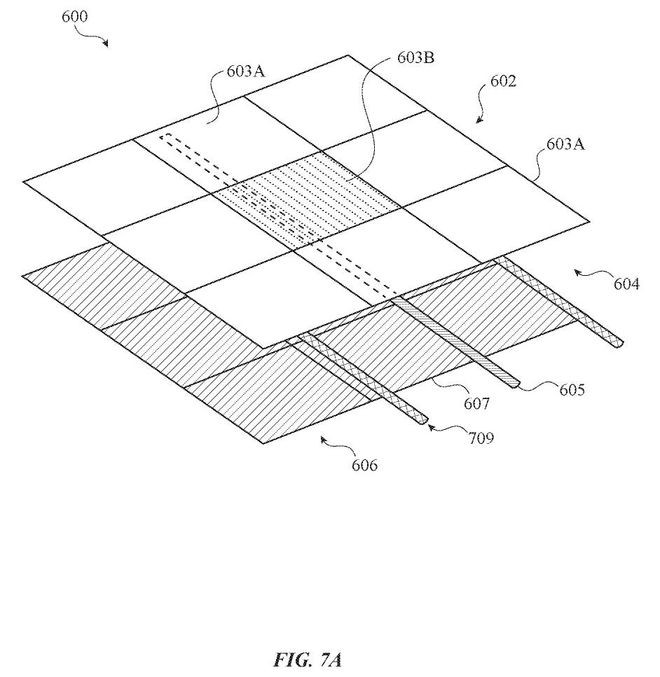

In some examples, a touch sensor panel or touch screen can include a drift sensor. For example, some or all of the touch electrodes of a touch screen can be formed from conductive material (e.g., ITO, metal, metal mesh, etc.) in one or more layers (as describe above with reference to FIGS. 4A-4B or FIG. 5). In some examples, such as in FIG. 4B, the pixelated self-capacitance touch electrodes can be implemented in a first conductive layer (e.g., in a similar position in a stack-up to the second metal layer 506 in FIG. 5). Additionally, in some examples, one or more drift traces can be implemented in a second conductive layer (e.g., in a similar position in a stack-up to the first metal layer 516 in FIG. 5). The first conductive layer and the second conductive layer can be separated by an intermediate dielectric layer (e.g., corresponding to intermediate layer / passivation layer 507). The touch sensor panel including the drift sensor can be disposed on a display of a touch screen. For example, the second conductive layer can be disposed on an encapsulation layer of the display. Additional details about the touch screen or touch sensor panel including a drift sensor are described with reference to FIGS. 6A-6B, 7A-7B, and 8.

As described herein, a touch screen includes a touch sensor panel and a display. In some touch screen technologies, the touch sensor panel and display are integrated in a touch screen, such as using an on-cell touch technology where the touch sensor panel is directly integrated and/or fabricated onto the display. Some touch sensor panels use pixelated self-capacitance touch sensing, which often provides increased higher signal-to-noise ratio (SNR) compared with mutual capacitance touch sensing. However, self-capacitance touch sensing and touch sensor panels are susceptible to drift (e.g., thermal drift), due to the relatively large (e.g., tens of pF) parasitic baseline capacitance formed between the touch electrodes and the display layers (e.g., the cathode electrodes). The drift degrades touch performance and is exacerbated as the encapsulation layer between touch sensor panel and display becomes thinner. The drift sensor described herein can be provided to compensate for drift and improve touch performance.

FIGS. 6A-6B illustrate views of a portion of an example touch sensor panel 600 including a drift sensor according to examples of the disclosure. As shown in FIGS. 6A-6B, the touch sensor panel 600 can include a plurality of touch electrodes 603A, 603B in a pixelated configuration in a first conductive layer 602. The touch sensor panel 600 includes a second conductive layer 604 including a drift trace 605. Display cathode electrodes 607 are also shown for reference in cathode layer 606. The drift trace enables a direct measurement of the local temperature, undisturbed by the presence of a touch on the cover glass, using a mutual capacitance 610 measurement between touch electrode 603B and drift trace 605 as described herein. This measurement of local temperature/thermal drift can be used by the sensing circuitry or one or more processors to subtract and remove (e.g., to compensate for) the thermal drift component of the measured self-capacitance at the plurality of touch electrodes that is present in the baseline capacitance 612 between the touch electrodes in the first conductive layer 602 and the cathode electrodes in the cathode layer 606. As a result, the inclusion of a drift sensor improves touch sensor performance.

In some examples, this process may be implemented by the sensing circuitry or the one or more processors as a two-part operation as discussed in further detail below. It is understood that although FIGS. 6A-6B show a portion of a touch sensor panel including a drift sensor, that the touch sensor panel can be larger and including more touch electrodes and more drift traces to enable larger touch sensor panels and multiple drift measurements at different regions of the panel. Each drift trace may provide a measurement of drift specific a specific region of the panel (e.g., touch electrode 603A, 603B), and the output of each local drift measurement may be applied to the measured self-capacitance to compensate for thermal drift at the respective touch electrodes in the corresponding region. In this manner, drift compensation may be performed locally, without averaging drift measurements across the entire panel, insomuch that variations in environmental conditions or sensor characteristics in different parts of the touch sensor panel are accounted for individually. In some examples, the drift compensation is applied on a per-node (e.g., per-touch pixel) basis for the touch panel for each captured touch frame. Performing localized drift compensation can be advantageous because the temperature and associated thermal drift may vary spatially on the panel and temporally based on operation of the touch sensor panel. For instance, when a user’s finger having a temperature different from that of the panel contacts the surface, localized heat transfer occurs at the point of contact and subsequently propagates laterally before dissipating spatially (e.g., localized to the point of contact) and temporally (e.g., removal of the finger). Therefore, better thermal drift compensation can be achieved compared with using an averaged or global temperature value for compensation, which could fail to account for such localized temperature variations.

During a first sensing operation, the touch electrodes can be scanned to generate a pixelated self-capacitance touch image. For example, the self-capacitance can drive the touch electrodes with a voltage waveform (from transmit circuitry (Tx circuitry) of the touch controller/sense circuitry (Rx circuitry)), and the accumulated charge on a set of sensed touch electrodes (receive circuitry of the touch controller/sense circuitry) is measured, generally resulting in a drift-inclusive touch signal. The entire touch sensor panel can be scanned by a single scan if enough sensing channels (e.g., one sensing channel per touch electrode) are included. Alternatively, a series of such scans can be performed when fewer sensing channels are available. In some examples, during the first sensing operation, the drift traces can be driven with the same Tx voltage waveform. In some examples, during the first sensing operation, the drift traces can be grounded.

During a second sensing operation (e.g., drift scan), the drift trace can be driven by a Tx voltage waveform, and the touch electrodes in the first conductive layer are grounded while the charge accumulation on a set of sensed (Rx) touch electrodes is measured (e.g., touch electrode 603B). Thus, the second sensing operation is essentially a mutual capacitance 610 scan between the touch electrode 603B and the drift trace 605. Because the first conductive layer is grounded, and fingers typically appear as grounded probes, the first conductive layer effectively shields the measured mutual capacitance signal from the finger. The measured capacitance is therefore primarily a function of the geometry and the dielectric constant of the dielectric layer between the first and second conductive layers. This dielectric constant will vary with local panel temperature; hence the measurement provides a direct measure of that local temperature. Because the drift scan is a pixelated scan, a temperature/drift signal for each touch electrode can be recorded, which then may be used to compensate for any temperature/drift signal potentially included in the signal from the first sensing operation (touch scan) for each touch electrode in the touchscreen.

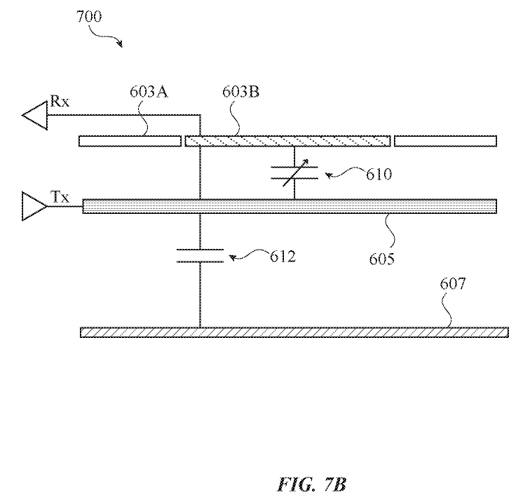

In some examples, in addition to drift traces in the second conductive layer 604, additional traces can be disposed in the second conductive layer 604. FIGS. 7A-7B illustrate views of a portion of an example touch sensor panel 700 including a drift sensor and additional electrodes according to examples of the disclosure. Specifically, as shown in FIGS. 7A-7B, additional traces 709 can be disposed in second conductive layer 604, and these additional traces 709 can be grounded. In some examples, the drift traces 605 and additional traces 709 in the second conductive layer 604 are the same electrodes which can be driven and/or grounded depending on the circumstances. For example, they may be grounded for shielding purposes or driven for bootstrapping purposes during the self-capacitance scan. Additionally, during the drift scan they can be driven for those portions of the panel at which drift sensing is performed and optionally grounded where drift sensing is not being performed. In some examples, drift scan includes multiple operations similar to the touch scan, depending on the number of available sense channels.

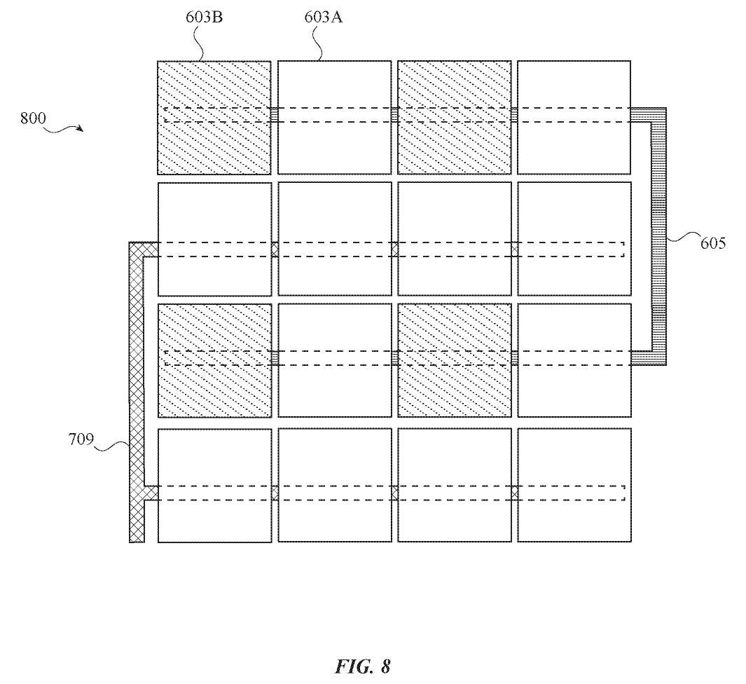

FIG. 8 illustrates a top-down view of a portion of a touch sensor panel 800 showing a four-by-four array of touch electrodes 603A, 603B in the first conductive layer, and multiple traces corresponding to drift traces 605 and additional traces 709 in the second conductive layer. As shown in FIG. 8, these traces in the second conductive layer can be interleaved (e.g., alternating rows), such that drift scan can be performed separately for each of the sets of traces (e.g., one operation for those rows corresponding to drift traces 605, and one operation for those rows corresponding to additional traces 709).

In some examples, the drift traces and additional traces are implemented as narrow strips compared with the touch electrodes. For example, the width of the traces can be 5%, 10%, 25%, 50%, etc. of the width of the touch electrodes in order to reduce the capacitance of traces to values that can effectively be driven to the required stimulus voltage waveform by the touch controller 206 or processor 202, taking into account the total capacitive loading as well as the series resistance of the traces, which result in the resistor-capacitor (RC) time constant of the drift sensor.

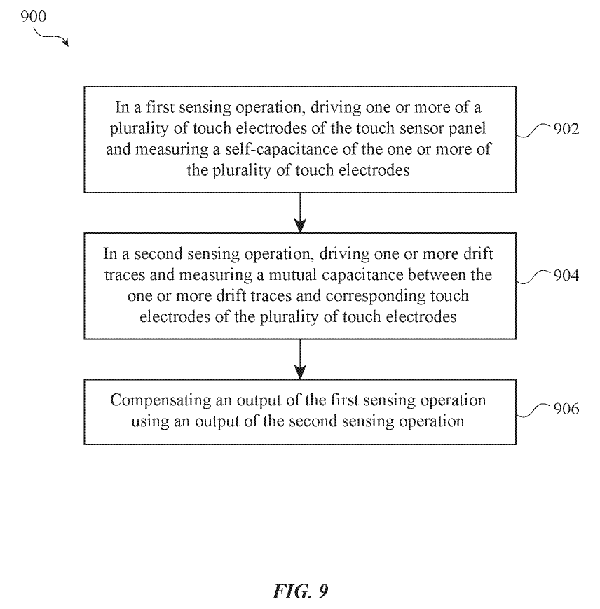

FIG. 9 illustrates a flow diagram illustrating an example process for driving one or more of a plurality of touch electrodes of a touch sensor panel and driving one or more drift traces, according to some examples of the disclosure. In some examples, process 900 is performed at a touch sensor panel that includes a drift sensor (or an electronic device including a such a touch sensor panel). In some examples, the touch sensor panel corresponds to any of the example systems illustrated in FIGS. 1A-1E. For example, process 900 may be implemented at mobile telephone 136, where the touch sensor panel optionally corresponds to touch screen 124. In some examples, the drift sensor corresponds to a portion of a touch sensor panel including a drift sensor, such as illustrated by FIGS. 6A-6B.

In some examples, process 900 includes operation 902. In some examples, operation 902 includes a first sensing operation comprising driving one or more of a plurality of touch electrodes and measuring a self-capacitance of the one or more of the plurality of touch electrodes according to some examples of the disclosure (e.g., a self-capacitance scan). In some examples, the one or more of the plurality of touch electrodes represent touch nodes of a touch sensor panel of touch screen 130 as illustrated in FIG. 1D. In some examples, operation 902 includes performing the first sensing operation at the one or more touch electrodes, such as touch electrodes 603A-603B in the first conductive layer 602 of FIGS. 6A-6B. During this operation, the touch electrodes may be driven with an electrical signal (e.g., from the touch controller 206), and the self-capacitance of the respective electrodes is measured (e.g., as described with reference to FIG. 3A) to generate a pixelated touch signal (e.g., as illustrated by baseline capacitance 612 between the touch electrodes and the cathode electrodes 607 of cathode layer 606). In some examples, the drift traces 605 may be grounded or driven concurrently with the same waveform, depending on implementation. The output of this first sensing operation may correspond to a raw touch measurement that includes any environmental or thermal drift present at the touch electrodes.

In some examples, process 900 includes operation 904. In some examples, operation 904 includes a second sensing operation comprising driving one or more drift traces and measuring a mutual capacitance between drift traces and corresponding touch electrodes according to some examples of the disclosure. In some examples, the second sensing operation occurs at a touch sensor panel that includes one or more drift traces, such as drift trace 605 illustrated in FIGS. 6A-6B. During this operation (e.g., operation 904), the one or more drift traces are driven with an electrical signal (e.g., from the touch controller 206), while the corresponding touch electrodes, such as touch electrodes 603A-603B in the first conductive layer 602, are grounded (e.g., via the sensing circuitry). The sensing circuitry measures the mutual capacitance between each drift trace and its corresponding touch electrode (e.g., as described with reference to FIG. 3B), resulting in a localized drift signal for each region of the touch sensor panel. Because the first conductive layer is grounded (and the first conductive layer separates the second conductive layer from a user’s finger), the measured mutual capacitance is largely unaffected by user touches, allowing the measurement to reflect environmental or thermal drift at each electrode location. In some examples, this localized drift measurement is recorded for each touch electrode (or for a subset of the touch electrodes) and later used to compensate the raw self-capacitance measurements obtained during the first sensing operation (e.g., operation 904), enabling drift-compensated touch detection across the panel.

In some examples, process 900 includes operation 906. In some examples, operation 907 includes compensating an output of the first sensing operation using an output of the second sensing operation according to some examples of the disclosure. For example, the drift-inclusive self-capacitance signal measured at the touch electrodes (e.g., each touch node or a subset of touch nodes), such as touch electrodes 603A or 603B in the first conductive layer 602 of FIGS. 6A-6B, may be adjusted by subtracting or otherwise accounting for the corresponding localized drift signal measured at the associated drift trace of drift traces 605 in the second conductive layer 604. This compensation may remove the component of the self-capacitance signal attributed to environmental and/or thermal drift, such as variations in dielectric constant between the first and second conductive layers due to local temperature changes, while preserving the portion of the signal corresponding to actual touches. In some examples, the compensated signal can then be processed by the touch controller or one or more processors to generate a drift-compensated touch image across the touch sensor panel, improving the accuracy and reliability of touch detection in the presence of local environmental variations.

It is understood that process 900 is an example and that more, fewer, or different operations can be performed in the same or in a different order. Additionally, the operations in process 900 described above are, optionally, implemented by running one or more functional modules at an electronic device (e.g., as described with respect to FIGS. 1A-2) or application specific chips, and/or by other components of FIGS. 1A-2.

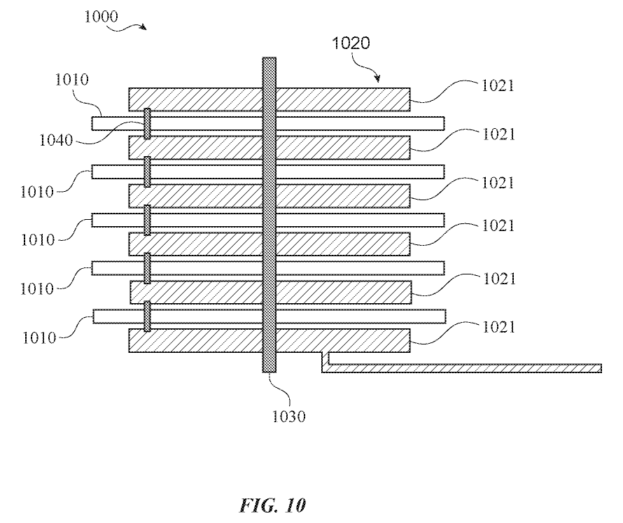

FIG. 10 illustrates a view of a portion of an example touch sensor panel 1000 including a drift sensor implemented in a mutual capacitance sensing architecture, according to examples of the disclosure. In some examples, the portion of the touch sensor panel illustrated in FIG. 10 may be implemented using two conductive layer similar to those described above with respect to FIGS. 6A-6B, 7A-7B, and 8. For example, the portion of the touch sensor panel 1000 of FIG. 10 may include a first conductive layer (e.g., illustrated in FIG. 10 by components including hash shading or no shading) disposed above a display (such as described above with reference to FIGS. 6A-6B, 7A-7B, and 8) and a second conductive layer (e.g., illustrated in FIG. 10 by components including fill shading) disposed on an encapsulation layer of the display, with a dielectric layer separating the first conductive layer from the second conductive layer.

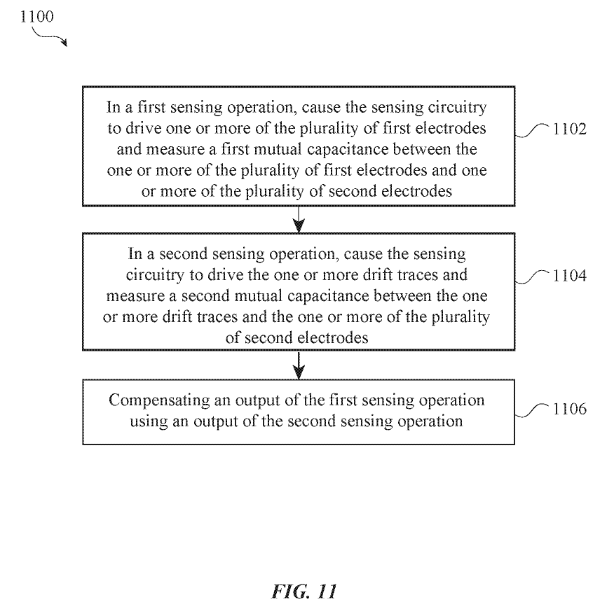

Unlike FIGS. 6A-6B, 7A-7B, and 8, the portion of the touch sensor panel 1000 may include electrodes in the first conductive layer to implement mutual capacitance sensing. For example, similar to the description of FIG. 4A, the portion of the touch sensor panel 1000 can include electrodes arranged as drive and sense lines that may be at least partially adjacent to each other on the same layer and/or may cross over each other on a different layer (e.g., bridges 1040 in a second conductive layer). For example, the first conductive layer includes a plurality of first electrodes (e.g., “drive” electrodes in the context of the mutual capacitance operation of FIG. 10 corresponding to operation 1102 discussed in further detail below with reference to FIG. 11) and a plurality of second electrodes (e.g., “sense” electrodes in the context of the mutual capacitance operation of FIG. 10) arranged in an interleaved electrode pattern conducive for mutual capacitance sensing. For the portion of the touch sensor panel 1000 in FIG. 10, a plurality of first electrodes 1010 is illustrated and one second electrode 1020 comprising a plurality of sense segments 1021 is illustrated. In some examples, in such an arrangement, one or more touch nodes may be defined by mutual capacitance between a respective first electrode 1010 and an adjacent respective second electrode 1020. In some examples, such as illustrated in FIG. 10, the plurality of first electrodes 1010 may be arranged as elongate electrode strips extending in a first direction, and a second electrode 1020 (e.g., along a second direction, optionally orthogonal to the first direction) may be implemented using the plurality of sense segments 1021 extending generally parallel to the plurality of drive electrodes 1010, electrically connected by conductive bridges 1040. In some examples, each second electrode 1020 of an example touch sensor panel may comprise multiple spatially separated sense segments 1021 that are electrically coupled together to form a single second electrode (e.g., sense electrode).

In some examples, the plurality of first electrodes 1010 of FIG. 10 are a plurality of drive segments that are electrically coupled together (not shown) and/or driven with the same drive signal as one drive electrode, similar to the manner in which one or more touch electrodes may be driven during sensing operations described above. In such an example, the portion of FIG. 10 illustrates one touch node. In other examples, the plurality of first electrodes 1010 are not coupled together (e.g., drivable as different drive electrodes), and the portion of FIG. 10 illustrates multiple touch nodes.

In some examples, each second electrode 1020 of a plurality of second electrodes of a touch sensor panel may comprise a plurality of sense segments 1021 positioned adjacent to respective drive electrodes.

In some examples, the second conductive layer of FIG. 10 includes the conductive bridges 1040 that electrically couple sense segments of a given sense electrode, similar to the routing and interconnection features described above with respect to FIGS. 7A-7B and 8. The conductive bridges 1040 optionally extend orthogonal to the first electrodes and sense segments and may electrically connect the sense segments to form a second electrode (e.g., using vias between the first conductive layer and the second conductive layer. As shown, the second electrode is optionally routed (e.g., in a border region of the touch sensor panel) to sense circuitry.

In some examples, the second conductive layer of FIG. 10 further includes one or more drift traces 1030 configured to operate as a drift sensor, similar to the drift traces described above with respect to FIGS. 6A-6B, 7A-7B, and 8. In some examples, during a drift sensing operation, the one or more drift traces 1030 may be driven with a stimulation signal. As illustrated in FIG. 10, the one or more drift traces 1030 may extend orthogonal to the plurality of first electrodes 1010 and the plurality of sense segments 1021 and may be routed to a border region of the touch sensor panel (not shown).

Additionally, drift traces 1030 are implemented and arranged to be less sensitive to touch input, similar to the drift traces described above with respect to FIGS. 6A-6B, 7A-7B, and 8. During a drift sensing operation, the one or more drift traces are driven and a mutual capacitance between drift traces and corresponding second electrodes is measured. For example, a mutual capacitance is measured between drift trace 1030 and second electrode 1020 can be measured while the second electrode 1020 is grounded (e.g., virtual ground). In some examples, the plurality of first electrodes 1010 is also grounded.

Therefore, as shown in FIG. 10, the second conductive layer optionally serves both to provide bridges and/or routing for the sense segments and/or second electrodes and to support drift sensing functionality via the drift traces. It is understood that FIG. 10 illustrates one implementation of a mutual capacitance touch sensor panel, but other implementations are possible in conjunction with a drift sensor.

FIG. 11 illustrates an example process 1100 for operating a touch sensor panel including a drift sensor in a mutual capacitance sensing architecture. In some examples, process 1100 is performed at a touch sensor panel that includes a drift sensor (or an electronic device including a such a touch sensor panel). In some examples, the touch sensor panel corresponds to any of the example systems illustrated in FIGS. 1A-1E. For example, process 900 may be implemented at mobile telephone 136, where the touch sensor panel optionally corresponds to touch screen 124. In some examples, the drift sensor corresponds to a portion of a touch sensor panel including a drift sensor, such as illustrated by FIG. 10. In some examples, the process 1100 may be performed by a touch controller coupled to a touch sensor panel, such as the touch sensor panel described above with respect to FIG. 10.

In some examples, the process 1100 includes operation 1102. In some examples, operation 1102 includes a first sensing operation. During the first sensing operation, the touch sensor panel may be operated in a mutual capacitance touch sensing mode. For example, one or more drive electrodes of the touch sensor panel may be driven with a stimulation signal, and mutual capacitance between the one or more drive electrodes and one or more sense electrodes may be measured to detect touch input (e.g., as described herein with respect to FIGS. 3B and 4A). The output of this first sensing operation may correspond to a raw touch measurement that includes any environmental or thermal drift present at the touch electrodes. The mutual capacitance measured during the first sensing operation (e.g., operation 1102) may include a baseline component that varies due to temperature, dielectric properties, mechanical deformation, or other environmental factors.

In some examples, the process 1100 includes operation 1104. In some examples, operation 1104 includes a second sensing operation. During the second sensing operation, the touch sensor panel may be operated to measure a reference mutual capacitance for drift compensation. In some examples, the second sensing operation comprising driving one or more drift traces and measuring a reference mutual capacitance for drift compensation according to some examples of the disclosure. In some examples, the second sensing operation occurs at a touch sensor panel that includes one or more drift traces, such as drift trace 1030 illustrated in FIG. 10. During this operation (e.g., operation 1104), the one or more drift traces may be driven with an electrical signal from a touch controller, and sensing circuitry may measure a mutual capacitance between the one or more drift traces and one or more electrodes of the first conductive layer. Because the one or more drift traces are arranged to be less sensitive to touch input than the sense electrodes, the resulting mutual capacitance measurement may primarily reflect environmental or thermal drift rather than user touch. In some examples, the reference mutual capacitance measured during the second sensing operation is recorded and later used to compensate the mutual capacitance measurements obtained during the first sensing operation, enabling drift-compensated mutual capacitance touch detection across the panel.

In some examples, during the second sensing operation (e.g., operation 1104), the one or more drift traces may be driven with a stimulation signal, while the one or more electrodes of the first conductive layer (e.g., one or more of the first electrodes 1010 and/or second electrodes 1020 illustrated in FIG. 10) are grounded, floating, or sensed to measure a mutual capacitance between the driven one or more drift traces and the one or more electrodes of the first conductive layer. Because the drift traces are arranged to be less sensitive to touch input than the sense electrodes, the mutual capacitance measured during the second sensing operation (e.g., operation 1104) may primarily reflect drift rather than user touch.

In some examples, the process 1100 includes operation 1106 that includes a compensation operation. In some examples, operation 1106 includes compensating an output of the first sensing operation using an output of the second sensing operation according to some examples of the disclosure. For example, the mutual capacitance measurement obtained during the first sensing operation (e.g., operation 1102) may be adjusted by subtracting or otherwise accounting for the reference mutual capacitance measured during the second sensing operation (e.g., operation 1104). This compensation may remove the component of the mutual capacitance signal attributed to environmental and/or thermal drift, such as variations in dielectric constant between the first and second conductive layers due to local temperature changes, while preserving the portion of the signal corresponding to actual touches. In some examples, the compensated signal can then be processed by the touch controller or one or more processors to generate a drift-compensated mutual capacitance touch image across the touch sensor panel, improving the accuracy and reliability of touch detection in the presence of local environmental variations.

It is understood that process 1100 is an example and that more, fewer, or different operations can be performed in the same or in a different order. Additionally, the operations in process 1100 described above are, optionally, implemented by running one or more functional modules at an electronic device (e.g., as described with respect to FIGS. 1A-2) or application specific chips, and/or by other components of FIGS. 1A-2.

Therefore, according to the above, some examples of the disclosure are directed towards a touch sensor panel including a drift sensor. The touch sensor panel comprises a first conductive layer including a plurality of touch electrodes in a pixelated pattern and a second conductive layer including one or more drift traces. The second conductive layer is separated from the first conductive layer by a dielectric layer and the second conductive layer is disposed on an encapsulation layer of a display. The touch sensor panel comprises sensing circuitry coupled to the plurality of touch electrodes and the one or more drift traces and one or more processors. The one or more processors are configured to, in a first sensing operation, cause the sensing circuitry to drive one or more of the plurality of touch electrodes and measure a self-capacitance of one or more of the plurality of touch electrodes. Additionally, the one or more processors are configured to, in a second sensing operation, cause the sensing circuitry to drive the one or more drift traces and measure a mutual capacitance between the one or more drift traces and corresponding touch electrodes of the plurality of touch electrodes. Additionally, the one or more processors are configured to compensate an output of the first sensing operation using an output of the second sensing operation. Additionally or alternatively to one of more of the examples disclosed above, in some examples, the one or more processors are further configured to, in the first sensing operation, cause the sensing circuitry to drive the one or more drift traces with a drive signal corresponding to a drive signal used to drive the plurality of touch electrodes. Additionally or alternatively to one of more of the examples disclosed above, in some examples, the one or more processors are further configured to, in the first sensing operation, cause the sensing circuitry to ground the one or more drift traces. Additionally or alternatively to one of more of the examples disclosed above, in some examples, the one or more processors are further configured to, in the first sensing operation, cause the sensing circuitry to drive a first subset of the one or more drift traces and ground a second subset, different from the first subset, of the one or more drift traces. Additionally or alternatively to one of more of the examples disclosed above, in some examples, each of the one or more drift traces has a first dimension greater than a first dimension of a respective touch electrode of the plurality of touch electrodes and a second dimension smaller than a second dimension of the respective touch electrode. Additionally or alternatively to one of more of the examples disclosed above, in some examples, the first dimension of the drift trace is a length and the second dimension of the drift trace is a width. Additionally or alternatively to one of more of the examples disclosed above, in some examples, the width of the drift trace is less than half the width of the respective touch electrode. Additionally or alternatively to one of more of the examples disclosed above, in some examples, compensating the output of the first sensing operation mitigates thermal drift due to a capacitance between the plurality of touch electrodes in the first conductive layer and a plurality of cathode electrodes of the display. Additionally or alternatively to one of more of the examples disclosed above, in some examples, compensating the output of the first sensing operation includes subtracting the thermal drift corresponding to the output from the second sensing operation from the output of the first sensing operation.

Some examples of the disclosure are directed towards a touch screen comprising a display and a touch sensor panel as described by any of the examples presented above. Some examples of the disclosure are directed towards an electronic device comprising an energy storage device, communication circuitry, and a touch screen or a touch sensor panel as described by any of the examples presented above.

Some examples of the disclosure are directed to a method comprising, at a touch sensor panel including a drift sensor, in a first sensing operation, driving one or more of a plurality of touch electrodes of the touch sensor panel and measuring a self-capacitance of the one or more of the plurality of touch electrodes, in a second sensing operation, driving one or more drift traces and measuring a mutual capacitance between the one or more drift traces and corresponding touch electrodes of the plurality of touch electrodes, and compensating an output of the first sensing operation using an output of the second sensing operation.

Some examples of the disclosure are directed to a non-transitory computer storage medium. The non-transitory computer storage medium stories one or more programs. The one or more programs comprise instructions, which when executed by one or more processors of an electronic device including a touch sensor panel including a drift sensor, cause the electronic device to, in a first sensing operation, drive one or more of a plurality of touch electrodes of the touch sensor panel and measure a self-capacitance of the one or more of the plurality of touch electrodes; in a second sensing operation, drive one or more drift traces and measure a mutual capacitance between the one or more drift traces and corresponding touch electrodes of the plurality of touch electrodes; and compensate an output of the first sensing operation using an output of the second sensing operation.

Some examples of the disclosure are directed to a touch sensor panel including a drift sensor. The touch sensor panel comprises a first conductive layer including a plurality of first electrodes and a plurality of second electrodes and a second conductive layer including one or more drift traces. The second conductive layer is separated from the first conductive layer by a dielectric layer and the second conductive layer is disposed on an encapsulation layer of a display. The touch sensor panel comprises sensing circuitry coupled to the plurality of first electrodes, the plurality of second electrodes, and the one or more drift traces and one or more processors. The one or more processors are configured to, in a first sensing operation, cause the sensing circuitry to drive one or more of the plurality of first electrodes and measure a first mutual capacitance between the one or more of the plurality of first electrodes and one or more of the plurality of second electrodes. Additionally, the one or more processors are configured to, in a second sensing operation, cause the sensing circuitry to drive the one or more drift traces and measure a second mutual capacitance between the one or more drift traces and the one or more of the plurality of second electrodes. Additionally, the one or more processors are configured to compensate an output of the first sensing operation using an output of the second sensing operation. Additionally or alternatively to one of more of the examples disclosed above, in some examples, each respective touch node of the touch sensor panel corresponds to a respective mutual capacitance measured between a respective one of the plurality of first electrodes and a respective one of the plurality of second electrodes in the first sensing operation. Additionally or alternatively to one of more of the examples disclosed above, in some examples, the plurality of first electrodes is electrically coupled together in the second sensing operation. Additionally or alternatively to one of more of the examples disclosed above, in some examples, the second conductive layer further includes a plurality of conductive bridges. Additionally or alternatively to one of more of the examples disclosed above, in some examples, a respective second electrode of the plurality of second electrodes includes a plurality of conductive segments in the first conductive layer electrically coupled by conductive bridges formed at least in part in the second conductive layer.

Some examples of the disclosure are directed to a method comprising, at a touch sensor panel including a drift sensor, in a first sensing operation, driving one or more of a plurality of touch electrodes of the touch sensor panel and measuring a mutual capacitance of the one or more of the plurality of touch electrodes (e.g., one mutual capacitance per touch node), in a second sensing operation, driving one or more drift traces and measuring a mutual capacitance between the one or more drift traces and corresponding touch electrodes of the plurality of touch electrodes, and compensating an output of the first sensing operation using an output of the second sensing operation.

Some examples of the disclosure are directed to a non-transitory computer storage medium. The non-transitory computer storage medium stories one or more programs. The one or more programs comprise instructions, which when executed by one or more processors of an electronic device including a touch sensor panel including a drift sensor, cause the electronic device to, in a first sensing operation, drive one or more of a plurality of touch electrodes of the touch sensor panel and measure a mutual capacitance of the one or more of the plurality of touch electrodes (e.g., one mutual capacitance per touch node); in a second sensing operation, drive one or more drift traces and measure a mutual capacitance between the one or more drift traces and corresponding touch electrodes of the plurality of touch electrodes; and compensate an output of the first sensing operation using an output of the second sensing operation.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A touch sensor panel including a drift sensor, the touch sensor panel comprising:
a first conductive layer including a plurality of touch electrodes in a pixelated pattern;
a second conductive layer including one or more drift traces, wherein the second conductive layer is separated from the first conductive layer by a dielectric layer and the second conductive layer is disposed on an encapsulation layer of a display;
sensing circuitry coupled to the plurality of touch electrodes and the one or more drift traces; and
one or more processors configured to:
in a first sensing operation, cause the sensing circuitry to drive one or more of the plurality of touch electrodes and measure a self-capacitance of one or more of the plurality of touch electrodes;
in a second sensing operation, cause the sensing circuitry to drive the one or more drift traces and measure a mutual capacitance between the one or more drift traces and corresponding touch electrodes of the plurality of touch electrodes; and
compensate an output of the first sensing operation using an output of the second sensing operation.

2. The touch sensor panel of claim 1, wherein the one or more processors are further configured to:
in the first sensing operation, cause the sensing circuitry to drive the one or more drift traces with a drive signal corresponding to a drive signal used to drive the plurality of touch electrodes.

3. The touch sensor panel of claim 1, wherein the one or more processors are further configured to:
in the first sensing operation, cause the sensing circuitry to ground the one or more drift traces.

4. The touch sensor panel of claim 1, wherein the one or more processors are further configured to:
in the first sensing operation, cause the sensing circuitry to drive a first subset of the one or more drift traces and ground a second subset, different from the first subset, of the one or more drift traces.

5. The touch sensor panel of claim 1, wherein each of the one or more drift traces has a first dimension greater than a first dimension of a respective touch electrode of the plurality of touch electrodes and a second dimension smaller than a second dimension of the respective touch electrode.

6. The touch sensor panel of claim 5, wherein the first dimension of a respective drift trace of the one or more drift traces is a length and the second dimension of the respective drift trace is a width.

7. The touch sensor panel of claim 6, wherein the width of the respective drift trace is less than half the width of the respective touch electrode.

8. The touch sensor panel of claim 1, wherein compensating the output of the first sensing operation mitigates thermal drift due to a capacitance between the plurality of touch electrodes in the first conductive layer and a plurality of cathode electrodes of the display.

9. The touch sensor panel of claim 1, wherein compensating the output of the first sensing operation includes subtracting thermal drift corresponding to the output from the second sensing operation from the output of the first sensing operation.

10. A method comprising:
at a touch sensor panel including a drift sensor and sensing circuitry coupled to the touch sensor panel and the drift sensor;
in a first sensing operation, driving one or more of a plurality of touch electrodes of the touch sensor panel and measuring a self-capacitance of the one or more of the plurality of touch electrodes;
in a second sensing operation, driving one or more drift traces and measuring a mutual capacitance between the one or more drift traces and corresponding touch electrodes of the plurality of touch electrodes; and
compensating an output of the first sensing operation using an output of the second sensing operation.

11. The method of claim 10, further comprising:
in the first sensing operation, cause the sensing circuitry to drive the one or more drift traces with a drive signal corresponding to a drive signal used to drive the plurality of touch electrodes.

12. The method of claim 10, further comprising:
in the first sensing operation, cause the sensing circuitry to drive a first subset of the one or more drift traces and ground a second subset, different from the first subset, of the one or more drift traces.

13. The method of claim 10, wherein each of the one or more drift traces has a first dimension greater than a first dimension of a respective touch electrode of the plurality of touch electrodes and a second dimension smaller than a second dimension of the respective touch electrode.

14. The method of claim 10 wherein compensating the output of the first sensing operation mitigates thermal drift due to a capacitance between the plurality of touch electrodes in a first conductive layer of the touch sensor panel and a plurality of cathode electrodes of a display at the touch sensor panel.

15. The method of claim 10, wherein compensating the output of the first sensing operation includes subtracting thermal drift corresponding to the output from the second sensing operation from the output of the first sensing operation.

16. A non-transitory computer readable storage medium storing one or more programs, the one or more programs comprising instructions, which when executed by one or more processors of an electronic device including a touch sensor panel including a drift sensor and sensing circuitry coupled to the touch sensor panel and the drift sensor, cause the electronic device to:
in a first sensing operation, drive one or more of a plurality of touch electrodes of the touch sensor panel and measure a self-capacitance of the one or more of the plurality of touch electrodes;
in a second sensing operation, drive one or more drift traces and measure a mutual capacitance between the one or more drift traces and corresponding touch electrodes of the plurality of touch electrodes; and
compensate an output of the first sensing operation using an output of the second sensing operation.

17. The non-transitory computer readable storage medium of claim 16, wherein the one or more processors are further configured to:
in the first sensing operation, cause the sensing circuitry to drive the one or more drift traces with a drive signal corresponding to a drive signal used to drive the plurality of touch electrodes.

18. The non-transitory computer readable storage medium of claim 16, wherein the one or more processors are further configured to:
in the first sensing operation, cause the sensing circuitry to drive a first subset of the one or more drift traces and ground a second subset, different from the first subset, of the one or more drift traces.

19. The non-transitory computer readable storage medium of claim 16, wherein each of the one or more drift traces has a first dimension greater than a first dimension of a respective touch electrode of the plurality of touch electrodes and a second dimension smaller than a second dimension of the respective touch electrode.

20. The non-transitory computer readable storage medium of claim 16, wherein compensating the output of the first sensing operation mitigates thermal drift due to a capacitance between the plurality of touch electrodes in a first conductive layer of the touch sensor panel and a plurality of cathode electrodes of a display at the touch sensor panel.
